(19) United States
(12) Patent Application Publication
(10) Pub. No.: US 2008/0118815 A1
(43) Pub. Date: May 22, 2008

(54) Method for forming a micro fuel cell

(76) Inventors: John J. D'Urso, Chandler, AZ (US); Chowdary R. Koripella, Scottsdale, AZ (US)

Correspondence Address: INGRASSIA FISHER & LORENZ, P.C. (MOT), 7150 E. CAMELBACK ROAD, SUITE 325, SCOTTSDALE, AZ, 85251, US

(21) Appl. No.: 11/604,035

(22) Filed: Nov. 20, 2006

(51) Int. Cl. H01M 4/86; B01J 19/08; H01M 8/02

(52) U.S. Cl. 429/40; 216/67; 427/58; 427/123

(57) ABSTRACT

A method is provided for fabricating a fuel cell wherein corrosion of metal diffusion layers or catalysts supports is avoided. The method comprises forming first and second electrical conductors (22, 42) accessible at a surface of a substrate (12). The substrate (12) is etched to provide a channel (34, 36), and a multi-metal layer (82) is deposited on the surface of the substrate (12). At least one metal is etched from the multi-metal layer (82) forming a porous metal layer therefrom. A portion of the porous metal layer is etched resulting in an anode portion (89) aligned with the channel (34, 36) and coupled to the first electrical conductor (22), and a cathode portion (90) coupled to the second electrical conductor (42) and separated from the anode portion by a cavity (91). A first bi-continuous material (97) is formed over the porous metal layer (82) within at least one of the anode (89) and oxidant (90) portions. An electrocatalyst (94) is formed over the bi-continous material (97), the cavity (91) is filled with an electrolyte; and the center anode portion (89) and the cavity (91) are covered with a capping layer (98).

### RELATED APPLICATIONS

This application relates to U.S. application Ser. No. 11/363,790, Integrated Micro Fuel Cell Apparatus, filed 28 Feb. 2006, U.S. application Ser. No. 11/479,737, Fuel Cell Having Patterned Solid Proton Conducting Electrolytes, filed 30 Jun. 2006, and U.S. application Ser. No. 11/519,553, Method for Forming a Micro Fuel Cell, filed 12 Sep. 2006.

### FIELD OF THE INVENTION

The present invention generally relates to fuel cells and more particularly to a method of fabricating a micro fuel cell wherein corrosion of metal gas diffusion layers or catalysts supports is avoided.

### BACKGROUND OF THE INVENTION

Rechargeable batteries are currently the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. Depending upon the usage, the energy could last for a few hours to a few days. Recharging always requires access to an electrical outlet. The limited amount of stored energy and the frequent recharging are major inconveniences associated with batteries. Accordingly, there is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size, and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts. In the regime of interest, namely, a few hundred milliwatts, this dictates that a large volume is required to generate sufficient power, making it unattractive for cell phone type applications.

An alternative approach is to carry a high energy density fuel and convert this fuel energy with high efficiency into electrical energy to recharge the battery. Radioactive isotope fuels with high energy density are being investigated for portable power sources. However, with this approach the power densities are low and there also are safety concerns associated with the radioactive materials. This is an attractive power source for remote sensor-type applications, but not for cell phone power sources. Among the various other energy conversion technologies, the most attractive one is fuel cell technology because of its high efficiency of energy conversion and the demonstrated feasibility to miniaturize with high efficiency.

Fuel cells with active control systems and those capable of operating at high temperatures are complex systems and are very difficult to miniaturize to the 2-5 cc volume needed for cell phone application. Examples of these include active control direct methanol or formic acid fuel cells (DMFC or DFAFC), reformed hydrogen fuel cells (RHFC), and solid oxide fuel cells (SOFC). Passive air-breathing hydrogen fuel cells, passive DMFC or DFAFC, and biofuel cells are attractive systems for this application. However, in addition to the miniaturization issues, other concerns include supply of hydrogen for hydrogen fuel cells, lifetime and energy density for passive DMFC and DFAFC, and lifetime, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and accommodating the passage of fuel and an oxidant along and between cells. Additionally, the planar, stacked cells derive power only from a fuel/oxidant interchange in a cross-sectional area (x and y coordinates).

To design a fuel cell/battery hybrid power source in the same volume as a typical mobile device battery (10 cc-2.5 Wh), both a smaller battery and a fuel cell with high power density and efficiency would be required to achieve an overall energy density higher than that of the battery alone. For example, for a 4-5 cc (1.0-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize traditional fuel cell designs, and the resultant systems are still too big for mobile applications. A few micro fuel cell development activities have been disclosed using traditional silicon processing methods in planar fuel cell configurations, and in a few cases, porous silicon is employed to increase the surface area and power densities. See, for example, U.S. Patent/Publication Numbers 2004/0185323, 2004/0058226, U.S. Pat. No. 6,541,149, and 2003/0003347. However, the power densities of the air-breathing planar hydrogen fuel cells are typically in the range of 50-100 mW/cm². To produce 500 mW would require 5 cm or more active area. Further, the operating voltage of a single fuel cell is in the range of 0.5-0.7V. At least four to five cells need to be connected in series to bring the fuel cell operating voltage to 2-3V and for efficient DC-DC conversion to 4V in order to charge the Li ion battery. Therefore, the traditional planar fuel cell approach will not be able to meet the requirements in a 1-2 cc volume for a fuel cell in the fuel cell/battery hybrid power source for cell phone use.

Microfabricated fuel cells, however, still have the fundamental components of large scale fuel cells, or components which perform similar functions. Among these are gas diffusion layers, catalyst supports, and electrocatalysts. A porous metal able to function as one or more of these components may be formed by de-alloying a metal alloy such as AgAu, thereby providing a high surface area and serving as both a gas diffusion layer and a catalyst support. However, the use of gold and other noble metals such as silver, palladium, ruthenium, and platinum, while chemically stable in a fuel cell environment and easy to plate, are undesirable from a cost perspective, their low plating rates, and high equipment costs. Non-noble metals such as titanium, tantalum, aluminum, and magnesium are inexpensive and passivate under the acidic conditions in a fuel cell, but can be difficult to deposit. Non-noble metals such as nickel, copper, iron, zinc, chromium, and cobalt, are easy to deposit and inexpensive, but are often subject to corrosion at one of the electrodes (when contacting the electrocatalyst/electrolyte) resulting in ionic contamination.

Accordingly, it is desirable to provide an integrated micro fuel cell apparatus that derives power from a three-dimensional fuel/oxidant interchange having increased surface area and wherein corrosion of metal diffusion layers or catalysts supports is avoided while minimizing cost. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for fabricating a fuel cell wherein corrosion of metal diffusion layers or catalysts supports is avoided. The method comprises forming a porous metal having an anode side and a cathode side over a substrate. A barrier layer comprising a porous alloy is formed on at least one of the cathode side and the anode side. An electrolyte is positioned within the porous metal between the anode side and the cathode side and an electrocatalyst material is positioned on the barrier layer.

### BRIEF DESCRIPTION OF THE DRAWINGS

The present invention will hereinafter be described in conjunction with the following drawing figures, wherein like numerals denote like elements, and

FIGS. 1-14 are partial cross-sectional views of two fuel cells as fabricated in accordance with an exemplary embodiment;

FIG. 15 is a partial cross-sectional top view taken along the line 15-15 of FIG. 14;

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The main components of a micro fuel cell device are a proton conducting electrolyte separating the reactant gases of the anode and cathode regions, an electrocatalyst which helps in the oxidation and reduction of the gas species at the anode and cathode of the fuel cell, a gas diffusion region to provide uniform reactant gas access to the anode and cathode, and a current collector for efficient collection and transportation of electrons to a load connected across the fuel cell. Other optional components are an ionomer intermixed with electrocatalyst and/or a conducting support for electrocatalyst particles that help in improving performance. In fabrication of the micro fuel cell structures, the design, structure, and processing of the electrolyte and electrocatalyst are critical to high energy and power densities, and improved lifetime and reliability. However, metals that are easily plated tend to corrode in the acidic fuel cell environment and cannot be used as gas diffusion layers or catalysts supports. A process is described herein to eliminate this tendency of the metals to corrode by forming a bi-continuous material between the metal and the electrocatalyst to act as a barrier to corrosion. Corrosion of the metal is prevented by preventing contact with the electrocatalyst and the electrolyte. Once a suitable alloy is formed over the metal, one or more of the components of the alloy are selectively removed to form the bi-continuous material that allows for passage of the fuel.

This bi-continuous material may be formed by de-alloying a metal alloy such as silver/gold (with the silver being removed by etching), or silver/copper or platinum/copper (with the copper being removed by etching), thereby providing a high surface area and serving as both a gas diffusion layer and a catalyst support. In the case of copper containing alloys, the etching may be done by a chemical etch such as immersion in a sodium persulphate and sulfuric acid solution, or by an electrical chemical etch by applying an appropriate bias in a solution containing sulfate, chloride or other suitable ions. As used herein, the bi-continuous structure means one which is porous to a gas such as a fuel, e.g., hydrogen, or an oxidant, e.g. oxygen, but impervious to a liquid such as an electrolyte.

Fabrication of individual micro fuel cells comprises high aspect ratio three dimensional anodes and cathodes with sub-100 micron dimension provides a high surface area for electrochemical reaction between a fuel (anode) and an oxidant (cathode). At these small dimensions, precise alignment of the anode, cathode, electrolyte and current collectors is required to prevent shorting of the cells. This alignment may be accomplished by semiconductor processing methods used in integrated circuit processing. Functional cells may also be fabricated in ceramic, glass or polymer substrates. This method of fabricating a three-dimensional micro fuel cell has a surface area greater than the substrate and, therefore, higher power density per unit volume.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing just described produces fuel cells with the required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Gasses comprising an oxidant, e.g., ambient air, and a fuel, e.g., hydrogen, are supplied on opposed sides of the substrate. A porous barrier is created between a porous metal in the hydrogen receiving section and the electrocatalyst. A vertical channel (via) is created by front side processing before fabricating the fuel cell structure on the top allow the precise alignment of the hydrogen fuel access hole under the anode, with this method, without the need for higher dimensional tolerances required for the front to back alignment process, allows for the fabrication of much smaller size high aspect ratio cells.

In the three-dimensional micro fuel cell design of the exemplary embodiment with thousands of micro fuel cells connected in parallel, the current carried by each cell is small. In case of failure in one cell, in order to maintain a constant current, it will cause only a small incremental increase in current carried by the other cells in the parallel stack without detrimentally affecting their performance.

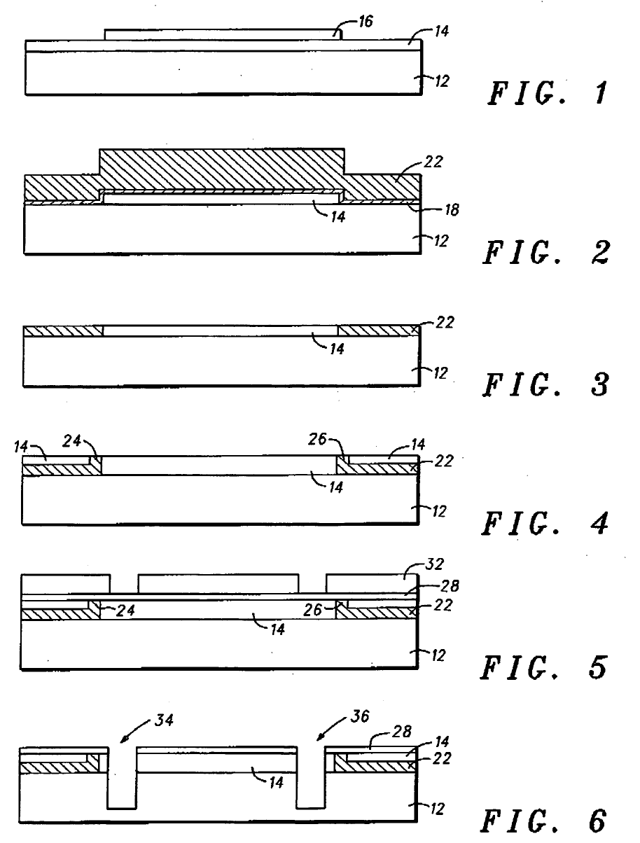

The exemplary embodiment described herein illustrate exemplary processes wherein a porous barrier is created between the electrocatalyst and a porous metal in the hydrogen receiving section or the oxidant section in the fabrication of fuel cells with a semiconductor-like process on silicon, glass, ceramic, plastic, metallic, or a flexible substrate. Referring to FIG. 1, a thin layer 14 of insulating film, preferably a TEOS oxide or Tetraethyl Orthosilicate (OC₂H₅)₄, is deposited on a substrate 12 to provide insulation for subsequent metallization layers which may be an electrical back plane (for I/O connections, current traces, etc.). An optional insulating layer may be formed between the substrate 12 and the thin layer 14. The thickness of the thin layer 14 may be in the range of 0.1 to 1.0 micrometers, but preferably would be 0.5 micrometers. A photoresist 16 is formed and patterned (FIG. 1) on the TEOS oxide layer 14 and the TEOS oxide layer 14 is etched (FIG. 2) by dry or wet chemical methods. The photoresist 16 is removed and a Tantalum/copper layer 18 is deposited on the substrate 12 and the TEOS oxide layer 14 to act as a seed layer for the deposition of a copper layer 22 for providing contacts to elements described hereinafter. The thickness of the Tantalum/copper layer 18 may be in the range of 0.05 to 0.5 micrometers, but preferably would be 0.1 micrometers. The copper layer 22 may have a thickness in the range of 0.05-2.0 micrometer, but preferably is 1.0 micrometer. Metals for the copper layer 22 other than copper, may include, e.g., gold, platinum, silver, palladium, ruthenium, and nickel.

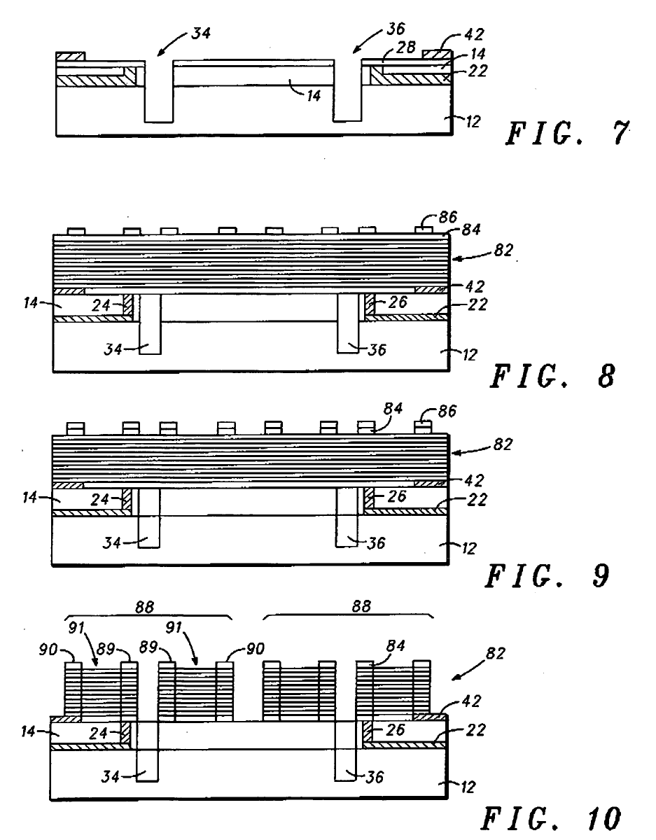

The copper layer 22 is formed with a chemical mechanical polish (FIG. 3), and further similar processing in a manner known to those skilled in the art results in the formation of vias 24, 26 integral to the copper layer 22 (FIG. 4). It should be noted that a lift off based process may be used to form the patterned layer 22 and vias 24, 26.

Referring to FIG. 5, in accordance with a first exemplary embodiment, an etch stop film 28 having a thickness of about 0.1 to 10.0 micrometers is formed by deposition on the TEOS oxide layer 14 and the vias 24, 26. The film 28 preferably comprises Titanium/gold, but may comprise any material to selectively deep silicon etch. Another photoresist 32 is formed and the pattern is transferred from the photoresist layer 32 to layer 28 and subsequently to layer 14 by wet or dry chemical etch processes. A deep reactive ion etch is performed to create channels 34, 36 (FIG. 6) to a depth of between 5.0 to 100.0 micrometers, for example. The channels 34, 36 preferably have a 1:10 aspect ratio with minimum feature size of 10 micrometers or smaller. The photoresist 32 is then removed.

Referring to FIG. 7, a second copper layer 42 is formed and patterned on the etch stop film 28 for providing contacts to elements described hereinafter (alternatively, a lift-off process could be used). The copper layer 42 may have a thickness in the range of 0.01-1.0 micrometers, but preferably is 0.1 micrometers. Metals for the copper layer 42 other than copper, may include, e.g., gold, platinum, silver, palladium, ruthenium, and nickel.

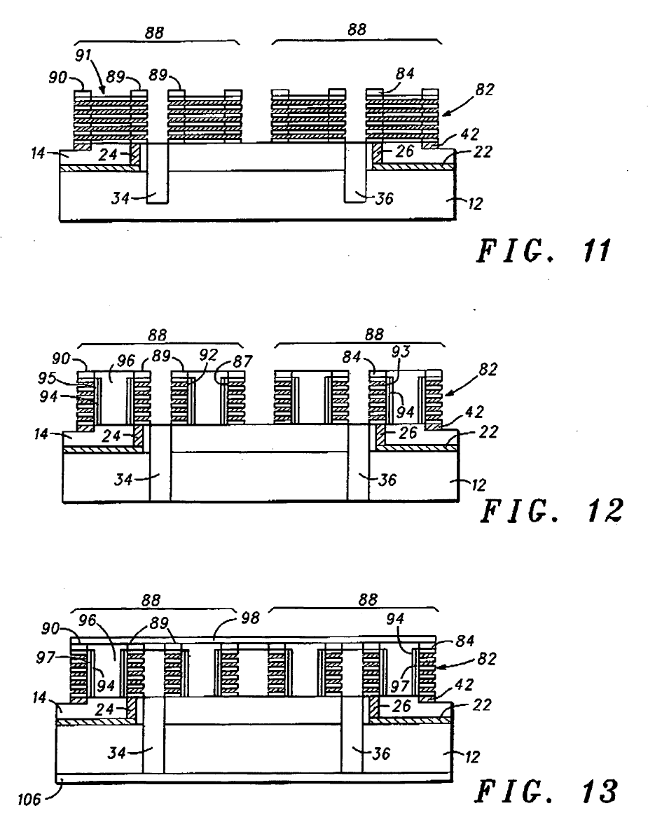

The method of forming anodes/cathodes over the thin layer 14, copper layer 42, and channels 34 and 36 will now be described. Referring to FIG. 8, multiple layers 82 comprise alternating conducting material layer, e.g., metals having an electrochemical standard reduction potential between minus 1.6 and a plus 0.8 volts, and more particularly between a minus 1.0 and a plus 0.34 volts, as the values are generally defined in the industry, selected from the group consisting of at least one of the metals nickel, copper, iron, zinc, chromium, cobalt, magnesium, technetium, rhodium, indium, tin, antimony, tellurium, selenium, rhenium, osmium, iridium, mercury, cadmium, lead, and bismuth, and having a thickness in the range of 100-500 um, but preferably 200 um (with each layer having a thickness of 0.1 to 10 micron, for example, but preferably 0.1 to 1.0 microns), are deposited on the copper layer 22 and a seed layer 28 above the layer 14. If the channels 34, 36 are small, they do not need to be plugged prior to depositing the multiple layers 82. A dielectric layer 84 is deposited on the multiple layers 82 and a resist layer 86 is patterned and etched on the dielectric layer 84.

Referring to FIGS. 9-10, using a chemical etch, the dielectric layer 84 not protected by the resist layer 86, is removed. Then, after the resist layer 86 is removed, the multiple layers 82, not protected by the dielectric layer 84, are removed to form a pedestal 88 comprising a center anode 89 (inner section) and a concentric cathode 90 (outer section) surrounding, and separated by a cavity 91 from, the anode 89. The pedestal 88 preferably has a diameter of 10 to 100 microns. The distance between each pedestal 88 would be 10 to 100 microns, for example. Alternatively, the anode 89 and cathode 90 may be formed simultaneously by templated processes. In this process, the pillars will be fabricated using a photoresist or other template process followed by a multi-layer metal deposition around the pillars forming the structure shown in FIG. 11. Concentric as used herein means having a structure having a common center, but the anode, cavity, and cathode walls may take any form and are not to be limited to circles. For example, the pedestals 88 may alternatively be formed by etching orthogonal trenches.

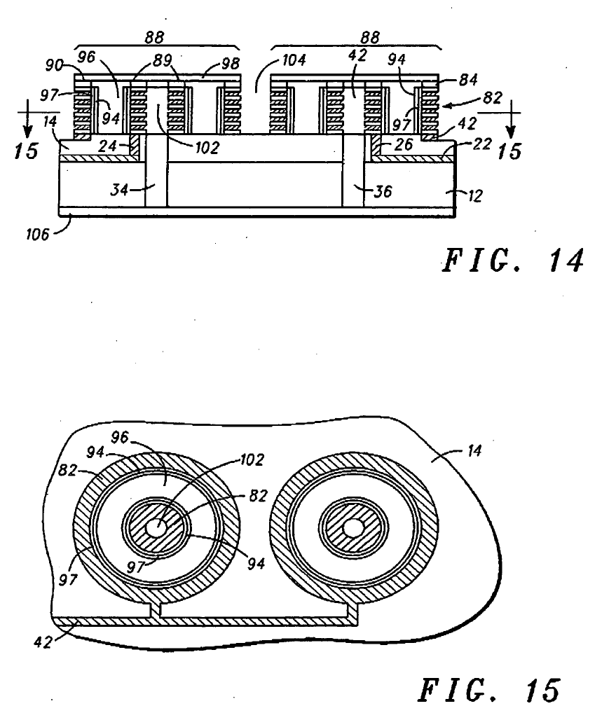

The multiple layers 82 of alternating metals are then wet etched to remove one of the metals, leaving behind layers of the other metal having a void between each layer (FIG. 12). When removing the alternate metal layers, care must be taken in order to prevent collapse of the remaining layers. This may be accomplished, with proper design, by etching so that some undissolved metal portions of the layers remain. This may be accomplished by using alloys that are rich in the metal being removed so the etching does not remove the entire layer. Alternatively, this may also be accomplished by a patterning of the layers to be removed so that portions remain between each remaining layer. Either of these processes allow for exchange of gaseous reactants through the multiple layers. The metal remaining/removed preferably comprises nickel/iron, but may also comprise, for example, nickel/copper or copper/nickel.

Still referring to FIG. 12 and in accordance with the second exemplary embodiment, a thin layer of an alloy metal 93, 95 is formed on the inner side wall 92 and the outer side wall 87, respectively. The alloy metal 93, 95 preferably is a metal alloy such as silver/gold (with the silver being removed by etching), or silver/copper or platinum/copper (with the copper being removed by etching), thereby providing a bi-continuous material 97 having a high surface area and serving as both a gas diffusion layer and a catalyst support. In the case of copper containing alloys, the etching may be done by a chemical etch such as immersion in a sodium persulphate and sulfuric acid solution, or by an electrical chemical etch by applying an appropriate bias in a solution containing sulfate, chloride or other suitable ions.

The bi-continuous metal 97 is then coated with an electrocatalyst 94 for anode and cathodic fuel cell reactions by wash coat or some other deposition methods such as CVD, PVD or electrochemical methods (FIG. 12). Then the layers 82 are etched down to the substrate 12 and an electrolyte material 96 is placed in the cavity 91, and the layer 28 not protected by the pedestals 88 and the conductive layer 42 is removed.

A capping layer 98 is formed (FIG. 13) and patterned (FIG. 14) above the electrolyte material 96. The electrolyte material 96 may comprise, for example, perflurosulphonic acid (Nafion®), phosphoric acid, or an ionic liquid electrolyte. Perflurosulphonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid. In the case of liquid electrolyte, the cavity needs to be capped to protect the electrolyte from leaking out.

FIG. 15 illustrates a top view of adjacent fuel cells fabricated in the manner described in reference to FIG. 14-20. The silicon substrate 12, or the substrate containing the micro fuel cells, is positioned on a structure (gas manifold) 106 for transporting hydrogen to the channels 34, 36. The structure 106 may comprise a cavity or series of cavities (e.g., tubes or passageways) formed in a ceramic material, for example. Hydrogen would then enter the hydrogen sections 102 of alternating multiple layers 82 above the cavities 34, 36. Since sections 102 are capped with the capping layer 98, the hydrogen would stay within the sections 102. Oxidant sections 104 are open to the ambient air, allowing air (including oxygen) to enter oxidant sections 104. It may be seen that the bi-continuous metal 97 is positioned between the metal multiple layers 82 and the electrocatalyst 94 for both the oxidant section 104 and the fuel section 102.

After filling the cavity 91 with the electrolyte material 94, it will form a physical barrier between the anode (hydrogen feed) and cathode (air breathing) regions 68, 74. Gas manifolds 106 are built into the bottom packaging substrate to feed hydrogen gas to all the anode regions. Since it is capped on the top, it will be like a dead end anode feed configuration fuel cell.

The exemplary embodiment disclosed herein provides a method of fabricating a fuel cell that avoids corrosion of metal diffusion layers or catalysts supports, requires only front side alignment and processing, increases the surface area for a gas to access the anode material, eliminates constraints on wafer size and thickness, and provides for sub-twenty micron vias for gas access to each cell for increasing cell, and hence, power density.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for fabricating a fuel cell, comprising:
providing a substrate;
forming a porous metal over the substrate having an anode side and a cathode side;
forming a barrier layer comprising a porous alloy on at least one of the cathode side and the anode side;
positioning an electrolyte within the porous metal between the anode side and the cathode side; and
forming a electrocatalyst material on the barrier layer.

2. The method of claim 1 wherein the forming a porous metal comprises:
forming an alloy of at least two metals having an electrochemical potential between minus 1.6 and a plus 0.8 volts; and
removing at least one of the at least two metals.

3. The method of claim 1 wherein the forming a porous metal comprises:
forming an alloy of at least two metals having an electrochemical potential between a minus 1.0 and a plus 0.34 volts; and
removing at least one of the at least two metals.

4. The method of claim 1 wherein the forming a porous metal comprises forming an alloy of at least two metals selected from the group consisting of the metals nickel, copper, iron, zinc, chromium, cobalt, magnesium, technetium, rhodium, cadmium, indium, tin, antimony, tellurium, selenium, rhenium, osmium, iridium, mercury, lead, and bismuth.

5. The method of claim 1 wherein the forming a barrier layer comprises forming an alloy that is passive when contacting at least one of an electrocatalyst and an electrolyte.

6. The method of claim 1 wherein the forming a barrier layer comprises forming an alloy comprising one of silver/gold, silver/copper, and platinum/copper.

7. A method for fabricating a fuel cell, comprising:
forming first and second electrical conductors accessible at a first side of a substrate;
etching the substrate to provide a channel;
depositing a multi-metal layer on the first side of the substrate;
etching at least one metal from the multi-metal layer forming a porous metal layer therefrom;
forming a portion of the porous metal layer resulting in a anode portion aligned with the channel and coupled to the first electrical conductor, and a cathode portion coupled to the second electrical conductor and separated from the anode portion by a cavity;
forming a bi-continuous material over the porous metal layer within at least one of the anode and oxidant portions;
forming an electrocatalyst over the bi-continous material;
filling the cavity with an electrolyte; and
capping the center anode portion and the cavity.

8. The method of claim 7 wherein forming the multi-metal layer comprises:
forming an alloy of at least two metals having an electrochemical potential between minus 1.6 and a plus 0.8 volts; and
removing at least one of the at least two metals.

9. The method of claim 7 wherein forming the multi-metal layer comprises:
forming an alloy of at least two metals having an electrochemical potential between a minus 1.0 and a plus 0.34 volts; and
removing at least one of the at least two metals.

10. The method of claim 7 wherein forming the multi-metal layer comprises forming an alloy of at least two metals selected from the group consisting of nickel, copper, iron, zinc, chromium, cobalt, magnesium, technetium, rhodium, cadmium, indium, tin, antimony, tellurium, arsenic, selenium, rhenium, osmium, iridium, mercury, thallium, lead, and bismuth.

11. The method of claim 7 wherein the forming a bi-continuous material comprises forming an alloy that is passive when contacting at least one of an electrocatalyst and an electrolyte.

12. The method of claim 7 wherein the forming a bi-continuous material comprises forming an alloy comprising one of silver/gold, silver/copper, and platinum/copper.

13. A fuel cell, comprising:
a substrate defining a channel;
first and second conductors positioned on the substrate;
a porous metal layer positioned on the first side of the substrate, a portion of the porous metal layer comprising a anode portion aligned with the channel and coupled to the first electrical conductor, and a cathode portion coupled to the second electrical conductor and separated from the anode portion by a cavity;
a bi-continuous material positioned over the porous metal layer within at least one of the anode and oxidant portions;
an electrocatalyst positioned over the bi-continous material;
an electrolyte positioned within the cavity; and
a capping layer positioned over the anode portion and the cavity.

14. The method of claim 13 wherein the porous metal layer comprises:
a metal having an electrochemical potential between minus 1.6 and a plus 0.8 volts.

15. The method of claim 13 wherein the porous metal layer comprises:
a metal having an electrochemical potential between a minus 1.0 and a plus 0.34 volts.

16. The method of claim 13 wherein the porous metal layer is selected from the group consisting of at least one of nickel, copper, iron, zinc, chromium, cobalt, magnesium, technetium, rhodium, cadmium, indium, tin, antimony, tellurium, selenium, rhenium, osmium, iridium, mercury, lead, and bismuth.

17. The method of claim 13 wherein the bi-continuous material comprises a metal that is passive when contacting at least one of an electrocatalyst and an electrolyte.

18. The method of claim 13 wherein the bi-continuous material comprises one of silver/gold, silver/copper, and platinum/copper.
